(19) United States
(12) Patent Application Publication
(10) Pub. No.: US 2018/0135770 A1
(43) Pub. Date: May 17, 2018

(54) APPARATUS AND METHODS FOR THERMALLY ACTIVATED MICRO-VALVE

(71) Applicant: Honeywell International Inc., Morris Plains, NJ (US)

(72) Inventors: Steven Tin, Plymouth, MN (US); Jeff A. Ridley, Shorewood, MN (US); Jong Park, Plymouth, MN (US)

(21) Appl. No.: 15/349,376

(22) Filed: Nov. 11, 2016

(51) Int. Cl. F16K 31/00; F16K 99/00; B23P 15/00

(52) U.S. Cl. CPC F16K 31/002; B23P 15/001; F16K 99/0036; F16K 99/0005

(57) ABSTRACT

In one embodiment, an apparatus is provided. The apparatus comprises a bilayer; and wherein the bilayer is configured to cover at least one opening in at least one chamber and irreparably opens upon reaching a threshold temperature.

### STATEMENT REGARDING FEDERALLY SPONSORED RESEARCH OR DEVELOPMENT

This invention was made with Government support under Government Contract Number FA8650-14-C-7402 awarded by USAF/AFMC. The Government has certain rights in the invention.

### BACKGROUND

Open once valves, or one shot valves, are used to release material, e.g. to create a chemical reaction. Such open once valves may be miniaturized with microelectronic techniques. Typically, microelectronic open once valves are formed with a conductor. High levels of current are supplied to the conductor to open the valve by electro-migration. Such high levels of current are not practical for many applications. Therefore, there is a need for an open once valve that is activated with a lower current level.

### SUMMARY

In one embodiment, an apparatus is provided. The apparatus comprises a bilayer; and wherein the bilayer is configured to cover at least one opening in at least one chamber and irreparably opens upon reaching a threshold temperature.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1A illustrates a cross-section of an exemplary chamber with a micro-valve;

FIG. 1B illustrates a cross-section of an exemplary pair of chambers with a micro-valve;

FIG. 2A illustrates a cross-section of an exemplary chamber with a micro-valve;

FIG. 2B illustrates a cross-section of another exemplary chamber with a micro-valve;

FIG. 3A illustrates a cross-section of yet another exemplary chamber with a micro-valve;

FIG. 3B illustrates a cross-section of a further exemplary chamber with a micro-valve;

FIG. 3C illustrates a cross-section of yet a further exemplary chamber with a micro-valve;

FIG. 4A illustrates a plan view of an exemplary micro-valve with a single heater;

FIG. 4B illustrates a plan view of an exemplary micro-valve with two heaters;

FIG. 4C illustrates a plan view of an exemplary micro-valve with three heaters;

FIG. 4D illustrates a plan view of an exemplary micro-valve with four heaters;

FIG. 4E illustrates a plan view of an exemplary heater;

FIG. 5 illustrates an exemplary electrical schematic of an open once micro-valve system;

FIG. 6 illustrates an exemplary method of operating an open once micro-valve; and

FIG. 7 illustrates an exemplary method of fabricating an open once micro-valve.

In accordance with common practice, the various described features are not drawn to scale but are drawn to emphasize specific features relevant to the exemplary embodiments. Reference characters denote like elements throughout figures and text.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that structural, mechanical, and electrical changes may be made. Furthermore, the method presented in the drawing figures and the specification is not to be construed as limiting the order in which the individual steps may be performed. The following detailed description is, therefore, not to be taken in a limiting sense.

A thermally activated, open once micro-valve may be used to overcome the above referenced problem. An open-once valve is a valve that can only be opened once. Thermal activation means that the temperature of a bilayer forming the micro-valve is sufficiently high, e.g. is at or above a threshold temperature, so as to cause the micro-valve to irreparably open.

The embodiments of a thermally activated, open once micro-valve have at least one advantage. The embodiments consume less power because of (a) differing coefficients of thermal expansion of at least two materials forming the micro-valve and (b) an increase of temperature of the materials, rather than electro-migration, are used to irreparably open the open the micro-valve.

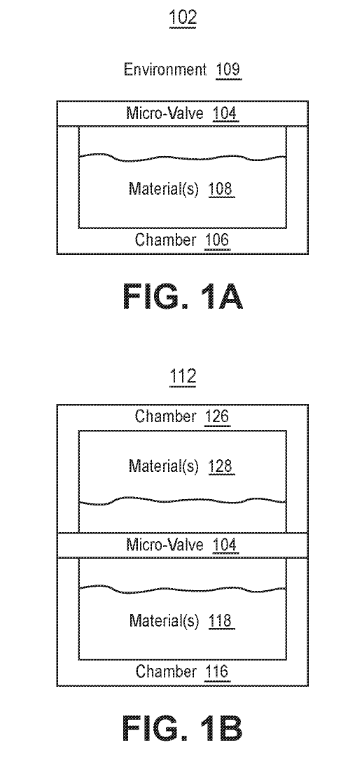

FIG. 1A illustrates a cross-section of one embodiment of a chamber 106 with a micro-valve 104. The micro-valve 104 is mounted, e.g. attached, directly or indirectly to cover an opening in the chamber 106.

The micro-valve 104 is formed by a bilayer which opens the micro-valve 104 upon reaching a threshold temperature. Thus, the threshold temperature is the temperature at which the bilayer alters its shape to irreparably open the micro-valve 104. Bilayer means at least two layers of material where at least two layers of material have different coefficients of thermal expansion. Thus, a bilayer is not limited to just two layers of material.

In one embodiment, the bilayer may include more than one layer of material having the same coefficient of thermal expansion to form effectively one layer of the bilayer. For example, two layers of oxide having the same coefficients of thermal expansion may be used because they have relatively different tensile stresses, relatively different compressive stresses, or respectively compressive and tensile stresses (in the axis parallel to the corresponding layer) which aid in opening the micro-valve 104 when the bilayer reaches the threshold temperature. This shall be further described subsequently.

In another embodiment, the chamber 106 can be formed from one or more materials, including without limitation a semiconductor, e.g. etched silicon, or molded plastic. In a further embodiment, the micro-valve 104 and chamber 106 contains at least one chamber material 108, e.g. a gas, solid and/or liquid. When the micro-valve 104 is thermally activated it opens and exposes the at least one material 108 to an environment 109. In yet a further embodiment, the at least one chamber material 108 may then react with and/or diffuse with the environment 109.

FIG. 1B illustrates a cross-section of one embodiment of a first chamber 116 and a second chamber 126 separated by a micro-valve 104. In a further embodiment, the micro-valve 104, and the first chamber 116 and the second chamber 126 respectively contain first chamber material(s) 118, e.g. a gas, solid and/or liquid, and second chamber material(s) 128, e.g. a gas, solid or liquid. When the micro-valve 104 is thermally activated it opens and exposes the first chamber material(s) 118 to the second chamber material(s) 128. In yet a further embodiment, the first chamber material(s) 118 may react with the second chamber material(s) 128.

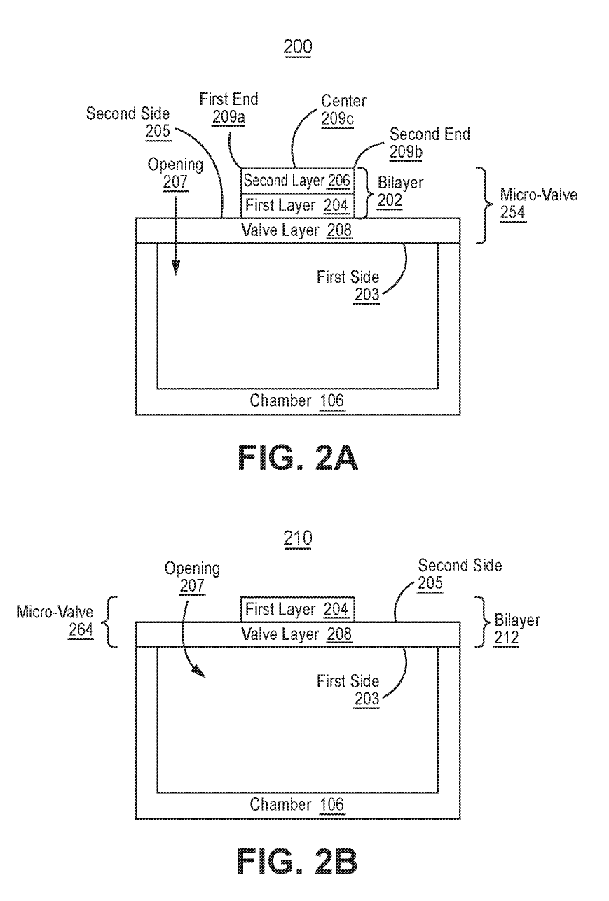

FIG. 2A illustrates a cross-section of another embodiment of a chamber 106 with a micro-valve 254. In one embodiment, the micro-valve 254 is formed by a valve layer 208 and a bilayer 202. The valve layer 208 has a first side 203 covering an opening 207 in the chamber 106. The bilayer 202 covers all or a portion of the second side 205 of the valve layer 208. In another embodiment, the valve layer 208 may be a conductor, insulator, or semiconductor which is sufficiently thin that it will be permanently ruptured or broken by stress applied by the bilayer 202.

In yet another embodiment, the bilayer 202 is formed by a second layer 206 covering all or a portion of a first layer 204. The first layer 204 covers all or a portion of the valve layer 208. The first layer 204 and the second layer 206 are formed by materials that have different coefficients of thermal expansion.

In one embodiment, the first layer 204 has a lower coefficient of thermal expansion than that of the second layer 206. Thus, the second layer 206 has a lower elastic modulus then the first layer 204. As a result, upon reaching a sufficient temperature, the bilayer 202 moves away from the chamber 106. (For example, temperature may change due to a change in the temperature of the local environment, or due to actuation of a thermal generator proximate to the micro-valve 254.) In another embodiment, a first end 209a and a second end 209b of the bilayer 202 will bend away from the center 209c of the bilayer 202 and away from the chamber 106. In a further embodiment, this will induce fractures in the valve layer 208 proximate to the first end 209a and the second end 209b. Upon reaching the threshold temperature, the micro-valve 254 will irreparably open.

FIG. 2B illustrates a cross-section of one embodiment of a chamber 106 with a micro-valve 264. In one embodiment, the micro-valve 264 is formed by a bilayer 212. The micro-valve 264 is similar to the micro-valve 254 in FIG. 2A, but does not have a second layer 206. In one embodiment, the bilayer 212 is formed by a valve layer 208 and a first layer 204. The valve layer 208 has a first side 203 covering an opening 207 in the chamber 106. A first layer 204 covers all or a portion of the second side 205 of the valve layer 208.

In one embodiment, the first layer 204 has a higher coefficient of thermal expansion than the valve layer 208. Thus, the valve layer 208 has a higher elastic modulus then the first layer 204. As a result, upon reaching a sufficient temperature, the bilayer 212 moves away from the chamber 106.

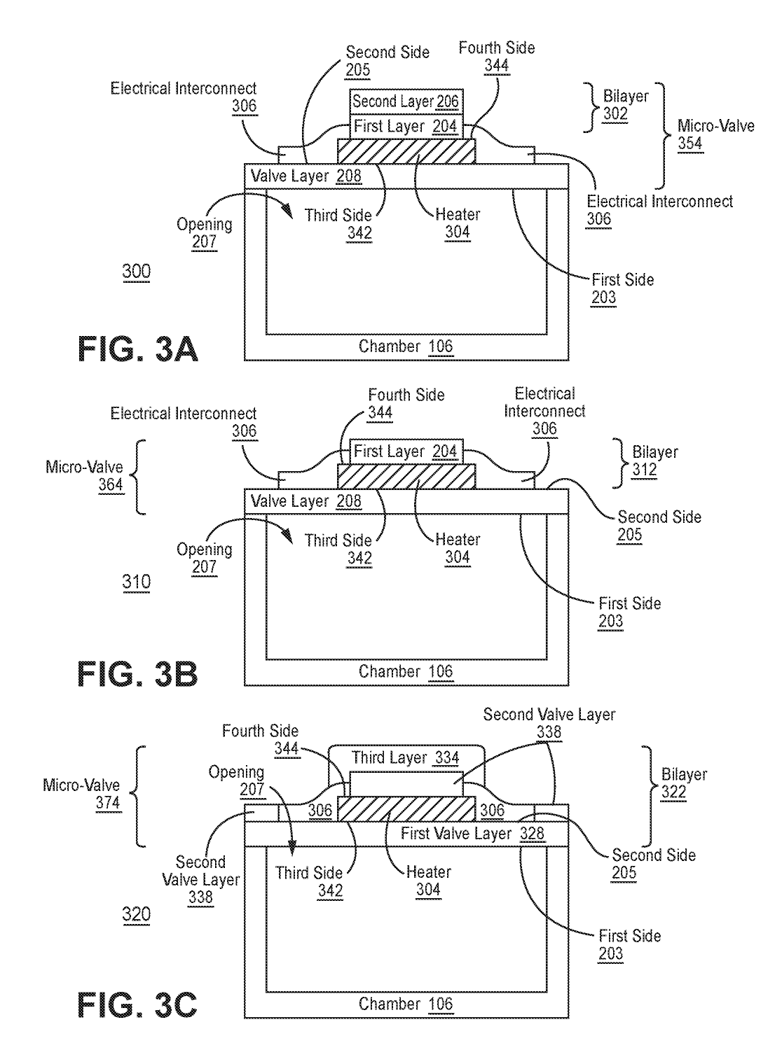

FIG. 3A illustrates a cross-section of one embodiment of a chamber 106 with a micro-valve 354 that includes a heater 304. In one embodiment, a heater 304 is in direct or indirect contact with a bilayer 302, and, when activated, generates thermal energy to heat the bilayer 302 to at least the threshold temperature needed to open the micro-valve 354 (in lieu of relying solely on an increase in ambient temperature to at least the threshold temperature).

In one embodiment, the micro-valve 354 is formed by a valve layer 208, heater 304, electrical interconnects 306, and a bilayer 302. The valve layer 208 has a first side 203 covering an opening 207 in the chamber 106. The heater 304 has a first side (referred to hereinafter as the third side 342), and a second side (referred to hereinafter as the fourth side 344). The third side 342 of the heater 304 covers all or a portion of the second side 205 of the valve layer 208.

A bilayer 302 covers all or a portion of the fourth side 344 of the heater 304. In yet another embodiment, the bilayer 302 is formed by a second layer 206 covering all or a portion of a first layer 204. The first layer 204 covers all or a portion of the fourth side 344 of the heater 304. The first layer 204 and the second layer 206 are formed by materials that have different coefficients of thermal expansion. In one embodiment, the first layer 204 is an oxide, and the second layer 206 is alumina.

In one embodiment, the first layer 204 has a lower coefficient of thermal expansion than the second layer 206. Thus, the second layer 206 has a lower elastic modulus then the first layer 204. As a result, upon sufficient increase in temperature of the bilayer 302, the bilayer 302 moves away from the chamber 106.

The heater 304 is made from resistive material such a conductor, insulator or semiconductor that converts electrical power to thermal power to generated increased localized temperatures. In one embodiment, the heater 304 is formed from NiCr or ‘nichrome.’

Electrical interconnects 306 contact the heater 304, and in one embodiment are formed on part of the second side 205 of the valve layer 208. The electrical interconnects 306 supply the electrical power to the heater 304 so that it can generate heat, and thus higher temperatures.

In one embodiment, the first layer 204 has a lower coefficient of thermal expansion than the coefficient of thermal expansion of the second layer 206. As a result, the first layer 204 has a higher elastic modulus, and, upon reaching a sufficient temperature, e.g. provided from the heater, generates movement of the bilayer 302 away from the chamber 106.

FIG. 3B illustrates a cross-section of a further embodiment of a chamber 106 with a micro-valve 364. In one embodiment, the micro-valve 364 is formed by a valve layer 208, electrical interconnects 306, and a bilayer 312. In this embodiment, the bilayer 312 includes the heater 304 and the first layer 204. The heater 304, when activated, generates thermal energy to heat the bilayer 312 to at least the threshold temperature needed to open the micro-valve 364

The valve layer 208 has a first side 203 covering an opening 207 in the chamber 106. The heater 304 has a first side (referred to hereinafter as the third side 342), and a second side (referred to hereinafter as the fourth side 344). The third side 342 of the heater 304 covers all or a portion of the second side 205 of the valve layer 208. A bilayer 312 is formed by the first layer 204 and the heater 304, where the first layer 204 covers all or a portion of the fourth side 344. The bilayer 312 operates in the present of increased temperature as described above.

In one embodiment, the first layer 204 has a higher coefficient of thermal expansion than the coefficient of thermal expansion of the heater 304. Thus, the heater 304 has a higher elastic modulus then the first layer 204. As a result, upon reaching a sufficient temperature, e.g. provided from the heater, the bilayer 312 moves away from the chamber 106.

FIG. 3C illustrates a cross-section of a yet a further embodiment of a chamber 106 with a micro-valve 374. In one embodiment, the micro-valve 374 is formed by a heater 304, electrical interconnects 306, and a bilayer 322. The bilayer 322 is formed by a first valve layer 328 and a second valve layer 338.

The first valve layer 328 has a first side 343 covering an opening 207 in the chamber 106. The heater 304 has a first side (referred to hereinafter as the third side 342), and a second side (referred to hereinafter as the fourth side 344). The third side 342 of the heater 304 covers all or a portion of the second side 205 of the first valve layer 328. A second valve layer 338 covers all or a portion of the fourth side 344 of the heater 304, and in one embodiment portions of the second side 205 of the first valve layer 328. A third layer 334 covers all or a portion of the second valve layer 338, and in one embodiment portions of electrical interconnects 306. The bilayer 322 is formed by the first valve layer 328, the second valve layer 338, and the third layer 334.

In one embodiment, the first valve layer 328 and the second valve layer 338 have the same coefficients of thermal expansion but have different tensile stresses, different compressive stresses, or respectively compressive and tensile stresses (in an axis parallel to the corresponding valve layer) as described above. In another embodiment, the first valve layer 328 has a lower tensile stress than the second valve layer 338. In a further embodiment, the first valve layer 328 has a greater compressive stress than the second valve layer 338. In yet a further embodiment, the first valve layer 328 has a compressive stress and the second valve layer 338 has a tensile stress. The differing stresses create a strain gradient in the vertical direction which causes curling when the micro-valve 374 is opened. The curling aids in expanding the opening in the micro-valve 374.

The third layer 334 has a higher coefficient of thermal expansion then the first valve layer 328 and the second valve layer 338. In one embodiment, the first valve layer 328 and the second valve layer 338 are oxides such as silicon dioxide, and the third layer 334 is an oxide such as alumina. Thus, the first valve layer 328 and the second valve layer 338 have a higher elastic modulus than the third layer 334. As a result, upon reaching a sufficient temperature, e.g. provided from the heater, generates movement of the bilayer 322 away from the chamber 106. Electrical interconnects 306 contact the heater 304, and in one embodiment are formed on part of the second side 205 of the first valve layer 328.

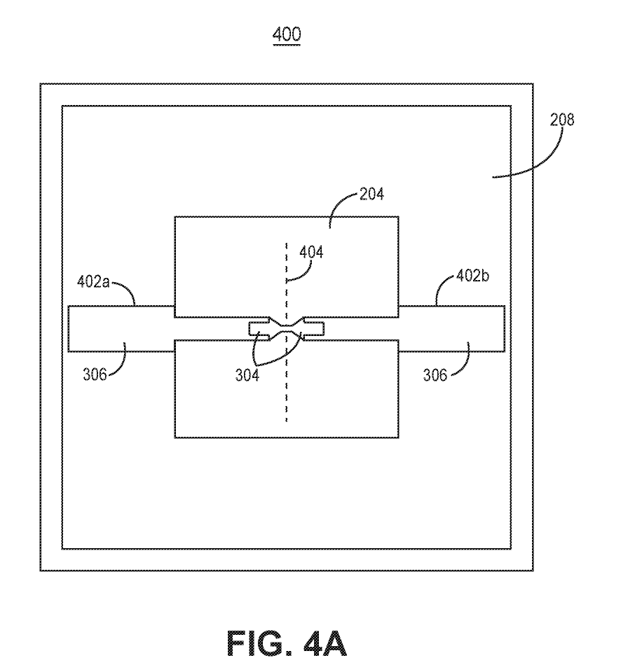

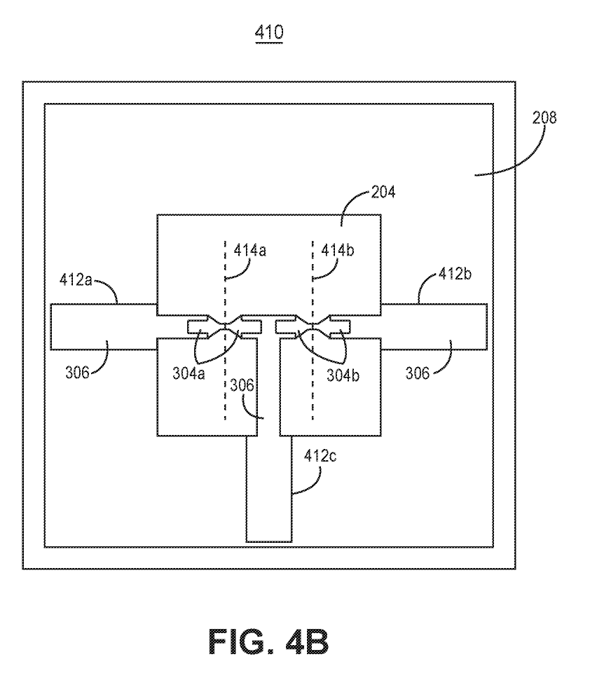

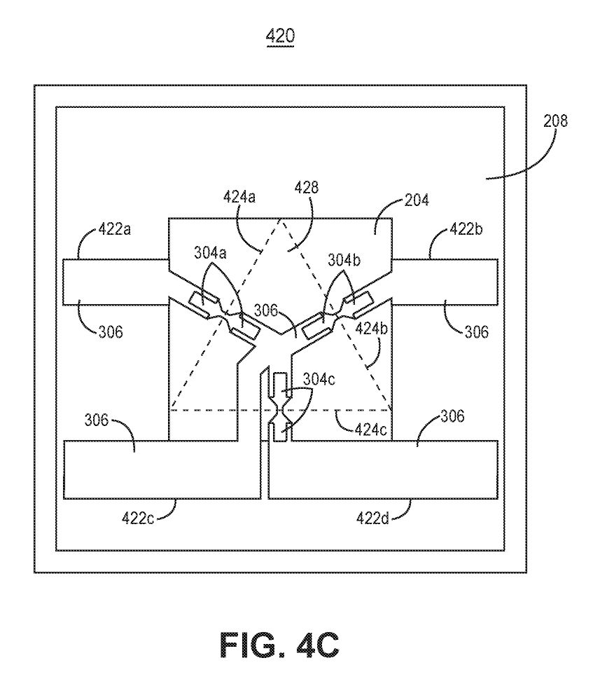

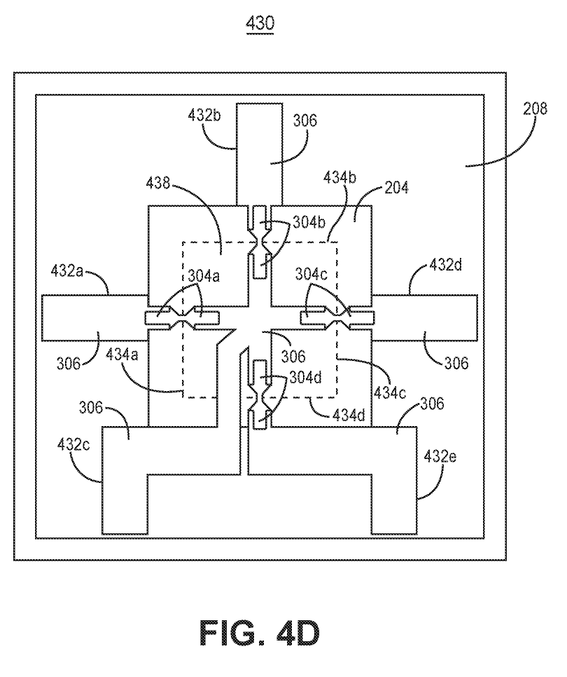

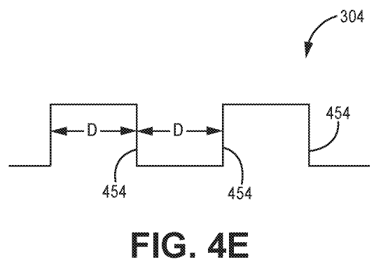

FIGS. 4A-4D illustrate a plan views of a micro-valves with a one 400, two 410, three 420, and four heaters 440. Increased number of heaters will increase the opening in the valve by creating more cracks in the micro-valve. FIGS. 4A-4D also illustrate the electrical interconnects 306 used in the micro-valves.

FIG. 4A illustrates a micro-valve 400 with one heater 304. Power to the heater 304 is provided through a first contact 402a and a second contact 402b. In one embodiment, such contacts may be bond pads to which wire or ribbons may be bonded. In another embodiment, upon the heater 304 generating at least the threshold temperature at the bilayer, a single crack 404, perpendicular to the heater 304, in the micro-valve 400 will form, and causes the micro-valve 400 to irreparably open.

FIG. 4B illustrates a micro-valve 410 with two heaters 304a, 304b. Power to the heaters 304a, 304b is provided through three contacts 412a, 412b, and 412c, including a common contact 412c, e.g. to be coupled to ground. In one embodiment, upon each heater 304a, 304b generating at least the threshold temperature at the bilayer, two parallel cracks 414a, 414b, each perpendicular to a respective heater 304a, 304b, in the micro-valve 410 will form, and cause the micro-valve 410 to irreparably open.

FIG. 4C illustrates a micro-valve 420 with three heaters 304a, 304b, 304c. Power to the heaters 304a, 304b, 304c is provided through four contacts 422a, 422b, 422c, 422d, including a common contact 422c, e.g. to be coupled to ground. In one embodiment, upon each heater 304a, 304b, 304c generating at least a threshold temperature at the bilayer, three cracks 424a, 424b, 424c, each perpendicular to a respective heater 304a, 304b, 304c in the micro-valve 420 will form, and cause the micro-valve 420 to irreparably open. Each crack is at a, or is about a, sixty-degree angle from the other cracks. The cracks 424a, 424b, 424c form an isosceles triangle 428. In one embodiment, the area within the isosceles triangle 428 is irreparably ruptured when the heaters 304a, 304b, 304c heat the bilayer to the threshold temperature.

FIG. 4D illustrates a micro-valve 430 with four heaters 304a, 304b, 304c, 304d. Power to the heaters 304a, 304b, 304c, 304d is provided through five contacts 432a, 432b, 432c, 432d, 432e including a common contact 432c, e.g. to be coupled to ground. In one embodiment, upon each heater 304a, 304b generating at least a threshold temperature at the bilayer, four cracks 434a, 434b, 434c, 434d, each perpendicular to a respective heater 304a, 304b, in the micro-valve 430 will form, and cause the micro-valve 430 to irreparably open. Each crack is at a, or is about a, ninety-degree angle from the other cracks. The cracks 434a, 434b, 434c, 434d form a square 438. In one embodiment, the area within the square 438 is irreparably ruptured when the heaters 304a, 304b, 304c, 304d heat the bilayer to the threshold temperature.

FIG. 4E illustrates a plan view of an exemplary heater 304 having heater elements 454, in a serpentine shape, formed from a layer of resistive material. The power density of the heater 304 can be increased or decreased by respectively decreasing or increasing the separation D between the heating elements 454, the width of the heater elements 454, and increasing or decreasing the length of the heater 304. However, in an alternative embodiment, the heater can be formed by a single, straight heater element 454 whose power density can be increased or decreased respectively by decreasing or increasing the width of the heater elements 454, and increasing or decreasing the length of the heater 304

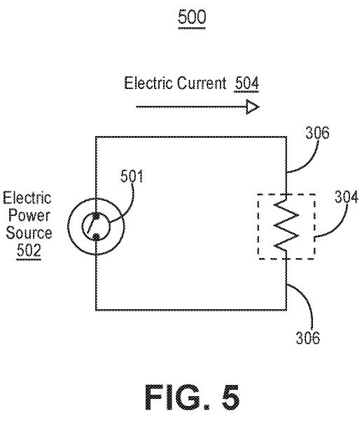

FIG. 5 illustrates an exemplary electrical schematic of an open once micro-valve system 500. An electrical power supply 502 is coupled to the heater 304 through the electrical interconnects 306. Electric current 504 flows from the electric power source 502, and through the electrical interconnects 306 and the heater 304. In one embodiment, the power consumption required to generate the threshold temperature and open the micro-valve is 25 milli-Watts, and the electrical power supply 502 would have to provide at least that amount of power. In another embodiment, the threshold temperature, necessary to open a micro-valve, is greater than 300 degrees Celsius. In a further embodiment, less than fifty milliamps of current is required by the heater 304 to open a micro-valve.

In one embodiment, the electrical power supply 502 includes a switch 501 to connect the electrical power supply 402 to the electrical interconnects 306. Thus, when the switch 501 is closed, current is supplied by the electrical power supply 502 to the heater 304 which then generates thermal energy. In one embodiment, the thermal energy heats the bilayer to the threshold temperature.

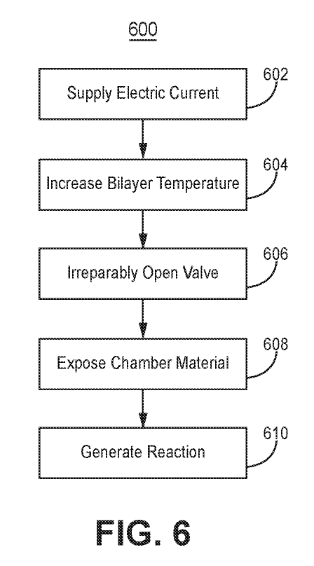

FIG. 6 illustrates an exemplary method 600 of operating an open once micro-valve. In block 602, electric current 504 is supplied to a heater 304 so that the heater 304 can generate thermal energy from electrical energy. In one embodiment, electric current 504 is supplied from an electrical power supply 502 as a result of a switch 501 being closed or actuated. In block 604, the temperature of the bilayer is increased, e.g. to at least the threshold temperature. In one embodiment, the temperature of the bilayer is increased, e.g. to the threshold temperature, with thermal energy generated from the heater 304. In block 606, the micro-valve is irreparably opened. In block 608, chamber material 108 is exposed in the chamber 106, e.g. to the environment. In one embodiment, because of the properties of diffusion, the chamber material 108 is released into the environment 109. In block 610, a reaction is generated with the exposed material, and, e.g. the environment 109 or other materials to which it is exposed. In one embodiment, the chamber material 108 is cesium rubidium and reacts with oxygen in the environment 109. In another embodiment, the generated reaction is an exothermic reaction, e.g. generating heat.

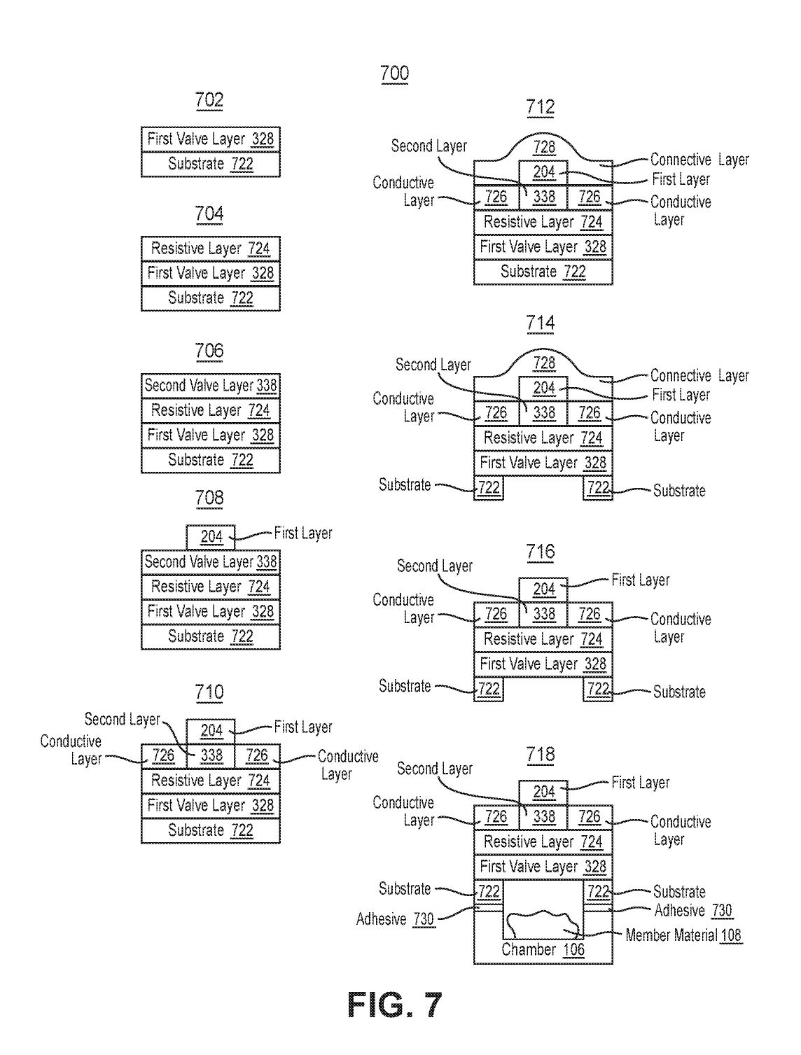

FIG. 7 illustrates an exemplary method of fabricating an open once micro-valve. In one embodiment, the micro-valve is one thousand microns wide and about three hundred microns thick (at its thickest point). In another embodiment, the micro-valve has an outer diameter of 2 millimeters, the bilayer has a 1 millimeter outer diameter centered in the center of the micro-valve, and is formed on a substrate, e.g. silicon, that is 0.3 millimeters thick.

In block 702, a first valve layer 328 is formed over, e.g. on, a substrate 722. In one embodiment, the substrate is a semiconductor such as silicon, e.g. which is polished on both sides. In another embodiment, the first valve layer 328 is a 2 micron layer of oxide deposited by plasma enhanced chemical vapor deposition (PECVD) at a temperature of 300 degrees Celsius.

In block 704, a resistive layer 724 is formed, e.g. deposited and patterned, over, e.g. on, the first valve layer 328. In one embodiment, the resistive layer 724 is NiCr having a resistance of 23 to 25 ohms per square and a thickness of about thirty nanometers. In another embodiment, the resistive layer 724 is patterned with photolithography using photoresist, and undesired portions of the resistive layer 724 are removed by ion milling, and the photoresist is removed, or stripped, with a wet process. The patterned resistive layer 724 forms the heater(s) 304.

In block 706, a second valve layer 338 is formed, e.g. deposited, over, e.g. on, the resistive layer 724 and the first valve layer 328. In one embodiment, the second valve layer 338 is a 1.3 micron layer of oxide deposited by plasma enhanced chemical vapor deposition (PECVD) at a temperature of 150 degrees Celsius. When the first valve layer 328 and the second valve layer 338 are oxide formed by PECVD respectively at 300 and 150 degrees, the second valve layer 338 has a higher tensile stress (in an axis parallel to the second valve layer 338) then the tensile stress (in an axis parallel to the first valve layer 328) in the first valve layer 328. The relative higher tensile stress assists the micro-valve to open further when activated by the threshold temperature.

In block 708, a first layer 204 is formed, e.g. deposited and patterned, over, e.g. on, the second valve layer 338. In one embodiment, the first layer 204 is alumina, e.g. formed by atomic layer deposition. In one embodiment, the alumina is patterned with photolithography using photoresist, and undesired portions of the alumina are removed by ion milling, and the photoresist is removed, or stripped, with a wet process.

In one embodiment, in block 710, a conductive layer 726 is formed, e.g. deposited and patterned, over, e.g. on, portions of the resistive layer 724 (excluding regions where the heater(s) 304 is to be formed). The conductive layer 726 is used to form the electrical interconnects 306. Thus, in this embodiment, the electrical interconnects 306 are formed by the conductive layer 726 on the resistive layer 714. In one embodiment the conductive layer 726 is formed with titanium and gold. In another embodiment, the photolithography using photoresist is used to create the regions where the titanium and gold are deposited, e.g. by sputtering. Undesired titanium and gold are then removed by a liftoff process.

In one embodiment, in block 712, a connective layer 728 is formed, e.g. deposited, over, e.g. on, the conductive layer 726 and the first layer 204. The connective layer 728 holds together more than one the micro-valve manufactured, e.g. en mass with a semiconductor wafer manufacturing process. In one embodiment, the connective layer 728 is polyimide, e.g. formed by a double coating of 2610 polyimide, which after deposition is baked at 300 degrees Celsius for two hours.

In block 714, a portion of the substrate 722 is removed under each micro-valve, forming a ring of substrate 722, e.g. around the periphery of the micro-valve. In one embodiment, the ring of substrate 722 is formed by removing a portion of the substrate 722 by patterning the substrate with photolithography and etching the portion of the substrate to be removed. The etch stops on the first valve layer 328. As a result, only the ring of substrate 722 remains around the periphery of the micro-valve. In one embodiment, photolithography using photoresist defines the area to be retained, and deep reactive ion etching is used to remove, with little undercut, the portion of substrate 722 inside the ring.

In block 716, the connective layer 728 is removed. In one embodiment, the connective layer, e.g. polyimide, is removed in a plasma asher.

In block 718, the micro-valve is attached, directly or indirectly, to a chamber 106, e.g. with an adhesive 730 such as epoxy. In another embodiment, chamber material 108 is placed in the chamber 106 before such attachment.

### Example Embodiments

Example 1 includes an apparatus, comprising: a bilayer; and wherein the bilayer is configured to cover at least one opening in at least one chamber and irreparably opens a micro-valve upon reaching a threshold temperature.

Example 2 includes the apparatus of Example 1, further comprising at least one heater in direct or indirect contact with the bilayer; wherein the at least one heater is configured to raise the temperature of the bilayer to at least the threshold temperature; at least two electrical interconnects; and wherein the at least two electrical interconnects are configured to couple the at least one heater to an electrical power supply.

Example 3 includes the apparatus of and of Examples 1-2, wherein the at least one heater is formed by a layer of resistive material having a serpentine shape.

Example 4 includes the apparatus of any of Examples 2-3, further comprising an electrical power supply coupled to the at least two electrical interconnects; the at least one chamber attached, directly or indirectly, to the bilayer; and at least one material in the chamber.

Example 5 includes the apparatus of any of Examples 1-4, wherein the bilayer includes at least one heater; and wherein the at least one heater is configured to raise the temperature of the bilayer to at least the threshold temperature; at least two electrical interconnects; and wherein the at least two electrical interconnects are configured to couple the at least one heater to an electrical power supply.

Example 6 includes the apparatus of Example 5, wherein the at least one heater is formed by a layer of resistive material having a serpentine shape.

Example 7 includes the apparatus of any of Examples 5-6, further comprising an electrical power source coupled to the at least two electrical interconnects; the at least one chamber attached, directly or indirectly, to the bilayer; and at least one material in the chamber.

Example 8 includes the apparatus of any of Examples 1-7, further comprising a valve layer; and wherein the valve layer is configured to cover the at least one opening in the at least one chamber.

Example 9 includes the apparatus of any of Examples 1-8, wherein the bilayer further compromises at least two layers having the same or substantially the same thermal coefficient of expansion, and, in the axes parallel to the at least two layers, different tensile stresses, different compressive stresses, or tensile and compressive stresses.

Example 10 includes a method, comprising: increasing the temperature of a bilayer to at least a threshold temperature; irreparably opening a micro-valve including the bilayer; and exposing at least one material covered by the micro-valve

Example 11 includes the method of Example 10, further comprises creating a reaction.

Example 12 includes the method of Example 11, wherein creating a reaction further comprises creating an exothermic reaction.

Example 13 includes the method of any of Examples 10-12, further comprising supplying current to a heater to increase the temperature of the bilayer.

Example 14 includes the method of Example 13, further comprising actuating a switch.

Example 15 includes a method of manufacture, comprising: forming a first valve layer over a substrate; forming a first layer over the first valve layer; forming a connective layer over the first layer; forming a ring of the substrate; and removing the connectivity layer.

Example 16 includes the method of manufacture of Example 15, further comprising forming a resistive layer over the first valve layer; and forming a conductive layer over a portion of the resistive layer.

Example 17 includes the method of manufacture of any of Examples 15-16, further comprising forming a second valve layer over the first valve layer.

Example 18 includes the method of manufacture of Example 17, further comprising forming a resistive layer over the first valve layer; and forming a conductive layer over a portion of the resistive layer.

Example 19 includes the method of manufacture of any of Examples 17-18, wherein forming the second valve layer over the first valve layer further comprises forming the second valve layer over the first valve layer wherein the second valve layer and the first valve layer have, in the axes parallel to the second valve layer and the first valve layer, different tensile stresses, different compressive stresses, or tensile and compressive stresses.

Example 20 includes the method of manufacture of any of Examples 17-19, wherein forming the second valve layer over the first valve layer further comprises forming the second valve layer at a lower temperature then a temperature at which the first valve layer was formed.

It will be evident to one of ordinary skill in the art that the processes and resulting apparatus previously described can be modified to form various apparatuses having different circuit implementations and methods of operation. Notwithstanding that the numerical ranges and parameters setting forth the broad scope of the present teachings are approximations, the numerical values set forth in the specific examples are reported as precisely as possible.

Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

While the present teachings have been illustrated with respect to one or more implementations, alterations and/or modifications can be made to the illustrated examples without departing from the scope of the appended claims. In addition, while a particular feature of the present disclosure may have been described with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. As used herein, the term “one or more of” with respect to a listing of items such as, for example, A and B or A and/or B, means A alone, B alone, or A and B. The term “at least one of” is used to mean one or more of the listed items can be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material.

The terms “about” or “substantially” indicate that the value or parameter specified may be somewhat altered, as long as the alteration does not result in nonconformance of the process or structure to the illustrated embodiment. Finally, “exemplary” indicates the description is used as an example, rather than implying that it is an ideal. Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. An apparatus, comprising:
a bilayer; and
wherein the bilayer is configured to cover at least one opening in at least one chamber and irreparably opens a micro-valve upon reaching a threshold temperature.

2. The apparatus of claim 1, further comprising at least one heater in direct or indirect contact with the bilayer;
wherein the at least one heater is configured to raise the temperature of the bilayer to at least the threshold temperature;
at least two electrical interconnects; and
wherein the at least two electrical interconnects are configured to couple the at least one heater to an electrical power supply.

3. The apparatus of claim 2, wherein the at least one heater is formed by a layer of resistive material having a serpentine shape.

4. The apparatus of claim 2, further comprising an electrical power supply coupled to the at least two electrical interconnects;
the at least one chamber attached, directly or indirectly, to the bilayer; and
at least one material in the chamber.

5. The apparatus of claim 1, wherein the bilayer includes at least one heater; and
wherein the at least one heater is configured to raise the temperature of the bilayer to at least the threshold temperature;
at least two electrical interconnects; and
wherein the at least two electrical interconnects are configured to couple the at least one heater to an electrical power supply.

6. The apparatus of claim 5, wherein the at least one heater is formed by a layer of resistive material having a serpentine shape.

7. The apparatus of claim 5, further comprising an electrical power source coupled to the at least two electrical interconnects;
the at least one chamber attached, directly or indirectly, to the bilayer; and
at least one material in the chamber.

8. The apparatus of claim 1, further comprising a valve layer; and
wherein the valve layer is configured to cover the at least one opening in the at least one chamber.

9. The apparatus of claim 1, wherein the bilayer further compromises at least two layers having the same or substantially the same thermal coefficient of expansion, and, in the axes parallel to the at least two layers, different tensile stresses, different compressive stresses, or tensile and compressive stresses.

10. A method, comprising:
increasing the temperature of a bilayer to at least a threshold temperature;
irreparably opening a micro-valve including the bilayer; and
exposing at least one material covered by the micro-valve.

11. The method of claim 10, further comprises creating a reaction.

12. The method of claim 11, wherein creating a reaction further comprises creating an exothermic reaction.

13. The method of claim 10, further comprising supplying current to a heater to increase the temperature of the bilayer.

14. The method of claim 13, further comprising actuating a switch.

15. A method of manufacture, comprising:
forming a first valve layer over a substrate;
forming a first layer over the first valve layer;
forming a connective layer over the first layer;
forming a ring of the substrate; and
removing the connectivity layer.

16. The method of manufacture of claim 15, further comprising forming a resistive layer over the first valve layer; and
forming a conductive layer over a portion of the resistive layer.

17. The method of manufacture of claim 15, further comprising forming a second valve layer over the first valve layer.

18. The method of manufacture of claim 17, further comprising forming a resistive layer over the first valve layer; and
forming a conductive layer over a portion of the resistive layer.

19. The method of manufacture of claim 17, wherein forming the second valve layer over the first valve layer further comprises forming the second valve layer over the first valve layer wherein the second valve layer and the first valve layer have, in the axes parallel to the second valve layer and the first valve layer, different tensile stresses, different compressive stresses, or tensile and compressive stresses.

20. The method of manufacture of claim 17, wherein forming the second valve layer over the first valve layer further comprises forming the second valve layer at a lower temperature then a temperature at which the first valve layer was formed.
